(19) United States
(12) Patent Application Publication
(10) Pub. No.: US 2016/0292511 A1
(43) Pub. Date: Oct. 6, 2016

(54) Scene and Activity Identification in Video Summary Generation

(71) Applicant: GoPro, Inc., San Mateo, CA (US)

(72) Inventors: Shishir Rao Ayalasomayajula, Cupertino, CA (US); Anandhakumar Chinnaiyan, Fremont, CA (US); Ravi Kumar Belagutti Shivanandappa, Santa Clara, CA (US)

(21) Appl. No.: 14/675,552

(22) Filed: Mar. 31, 2015

(51) Int. Cl. G06K 9/00; G11B 27/30; G11B 27/34

(52) U.S. Cl. CPC G06K 9/00751; G11B 27/34; G11B 27/3081; G06K 2009/00738

(57) ABSTRACT

Video and corresponding metadata is accessed. Events of interest within the video are identified based on the corresponding metadata, and best scenes are identified based on the identified events of interest. A video summary can be generated including one or more of the identified best scenes. The video summary can be generated using a video summary template with slots corresponding to video clips selected from among sets of candidate video clips. Best scenes can also be identified by receiving an indication of an event of interest within video from a user during the capture of the video. Metadata patterns representing activities identified within video clips can be identified within other videos, which can subsequently be associated with the identified activities.

### BACKGROUND

1. Technical Field

This disclosure relates to a camera system, and more specifically, to processing video data captured using a camera system.

2. Description of the Related Art

Digital cameras are increasingly used to capture videos in a variety of settings, for instance outdoors or in a sports environment. However, as users capture increasingly more and longer videos, video management becomes increasingly difficult. Manually searching through raw videos (“scrubbing”) to identify the best scenes is extremely time consuming. Automated video processing to identify the best scenes can be very resource-intensive, particularly with high-resolution raw-format video data. Accordingly, an improved method of automatically identifying the best scenes in captured videos and generating video summaries including the identified best scenes can beneficially improve a user's video editing experience.

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1 is a block diagram of a camera system environment according to one embodiment.

FIG. 2 is a block diagram illustrating a camera system, according to one embodiment.

FIG. 3 is a block diagram of a video server, according to one embodiment.

FIG. 4 is a flowchart illustrating a method for selecting video portions to include in a video summary, according to one embodiment.

FIG. 5 is a flowchart illustrating a method for generating video summaries using video templates, according to one embodiment.

FIG. 6 is a flowchart illustrating a method for generating video summaries of videos associated with user-tagged events, according to one embodiment.

FIG. 7 is a flowchart illustrating a method of identifying an activity associated with a video, according to one embodiment.

FIG. 8 is a flowchart illustrating a method of sharing a video based on an identified activity within the video, according to one embodiment.

FIG. 9 is a flowchart illustrating a method of uploading captured video to a server, according to one embodiment.

FIG. 10 is a block diagram illustrating a video capture environment, according to one embodiment.

FIG. 11 is a flowchart illustrating a method for identifying events of interest within video data, according to one embodiment.

FIG. 12 is a flowchart illustrating a method for identifying events of interest within video data at the point of video capture, according to one embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Described herein is a system that is configured to identify events of interest in video footage captured from a system of multiple cameras. A video server accesses video footage from one or more cameras, and accesses sensor data recorded by one or more sensor devices associated with a user (such as location-detecting sensor devices carried or worn by the user). For each camera, the server identifies one or more events of interests, including time intervals in the captured video footage during which sensor data indicates the presence of a user in the camera's field of view. For each time interval, the video server identifies and stores a video clip corresponding to each event of interest.

Also described herein is a system that is configured to identify events of interest using a beacon that is associated with a user. One or more cameras capture video footage over a fixed period of time. Each camera then identifies one or more intervals of time within the period of time during which a user is located in the camera's field of view, based on a signal transmitted by a beacon carried by and identifying a user. For each such interval, the camera generates metadata identifying an event of interest, and stores it in conjunction with the captured video.

### Example Camera System Configuration

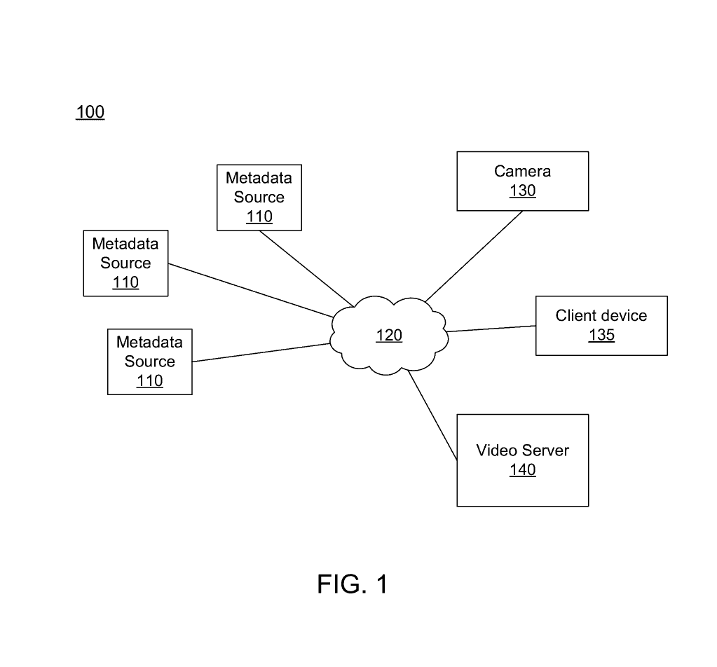

Referring now to FIG. 1, illustrated is a block diagram of a camera system environment, according to one embodiment. The camera system environment 100 includes one or more metadata sources 110, a network 120, a camera 130, a client device 135 and a video server 140. In alternative configurations, different and/or additional components may be included in the camera system environment 100. Examples of metadata sources 110 include sensors (such as accelerometers, speedometers, rotation sensors, GPS sensors, altimeters, and the like) and data sources (such as external servers, web pages, local memory, and the like). Although not shown in FIG. 1, it should be noted that in some embodiments, one or more of the metadata sources 110 can be included within the camera 130.

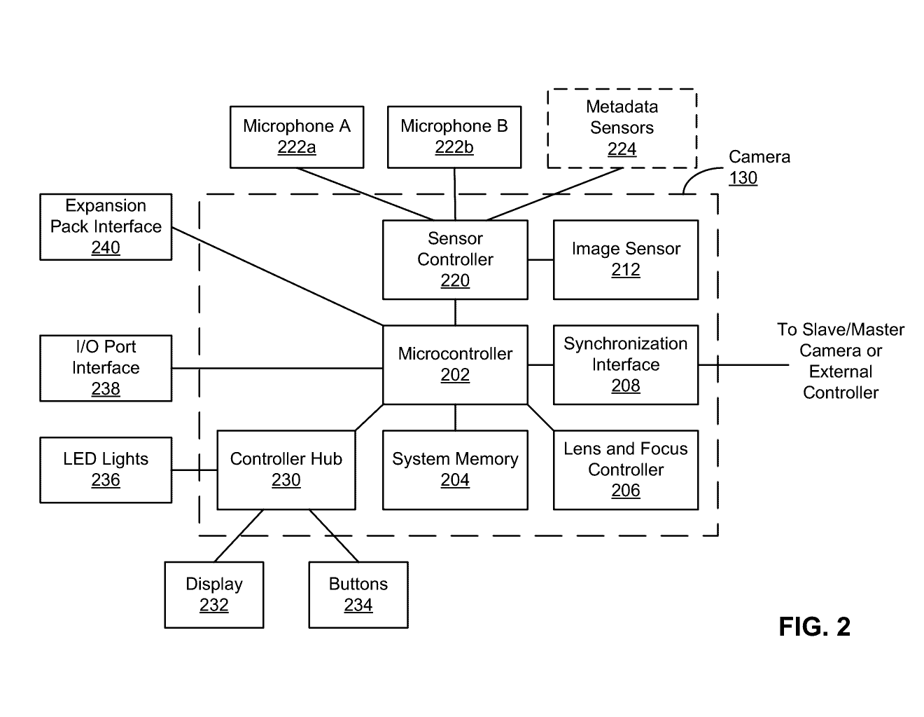

The camera 130 can include a camera body having a camera lens structured on a front surface of the camera body, various indicators on the front of the surface of the camera body (such as LEDs, displays, and the like), various input mechanisms (such as buttons, switches, and touch-screen mechanisms), and electronics (e.g., imaging electronics, power electronics, metadata sensors, etc.) internal to the camera body for capturing images via the camera lens and/or performing other functions. As described in greater detail in conjunction with FIG. 2 below, the camera 130 can include sensors to capture metadata associated with video data, such as motion data, speed data, acceleration data, altitude data, GPS data, and the like. A user uses the camera 130 to record or capture videos in conjunction with associated metadata which the user can edit at a later time.

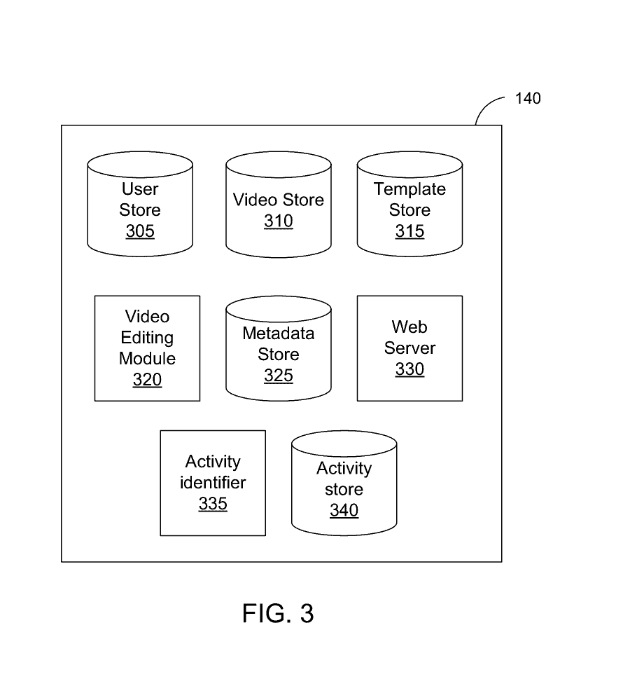

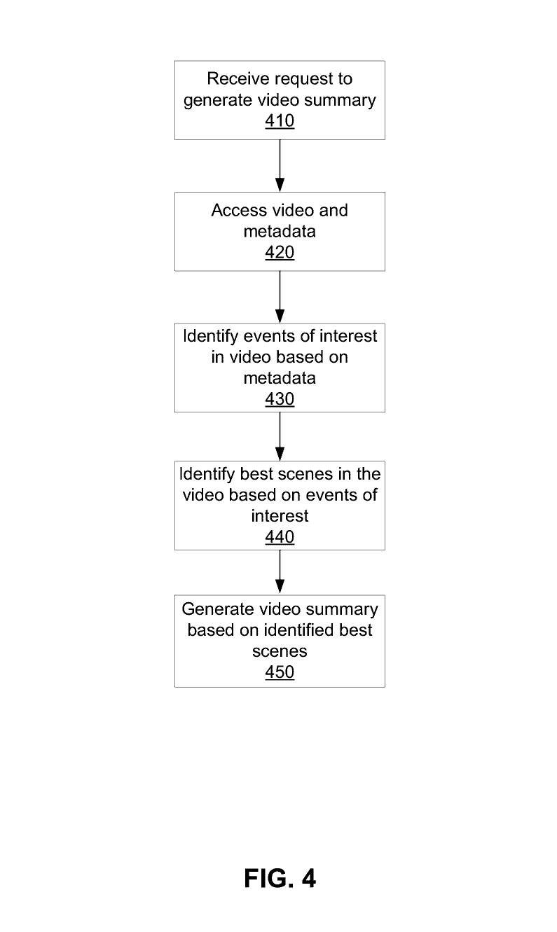

The video server 140 receives and stores videos captured by the camera 130 allowing a user to access the videos at a later time. In one embodiment, the video server 140 provides the user with an interface, such as a web page or native application installed on the client device 135, to interact with and/or edit the videos captured by the user. In one embodiment, the video server 140 generates video summaries of various videos stored at the video server, as described in greater detail in conjunction with FIG. 3 and FIG. 4 below. As used herein, “video summary” refers to a generated video including portions of one or more other videos. A video summary often includes highlights (or “best scenes”) of a video captured by a user. In some embodiments, best scenes include events of interest within the captured video, scenes associated with certain metadata (such as an above threshold altitude or speed), scenes associated with certain camera or environment characteristics, and the like. For example, in a video captured during a snowboarding trip, the best scenes in the video can include jumps performed by the user or crashes in which the user was involved. In addition to including one or more highlights of the video, a video summary can also capture the experience, theme, or story associated with the video without requiring significant manual editing by the user. In one embodiment, the video server 140 identifies the best scenes in raw video based on the metadata associated with the video. The video server 140 may then generate a video summary using the identified best scenes of the video. The metadata can either be captured by the camera 130 during the capture of the video or can be retrieved from one or more metadata sources 110 after the capture of the video.

Metadata includes information about the video itself, the camera used to capture the video, the environment or setting in which a video is captured or any other information associated with the capture of the video. For example, metadata can include acceleration data representative of the acceleration of a camera 130 attached to a user as the user captures a video while snowboarding down a mountain. Such acceleration metadata helps identify events representing a sudden change in acceleration during the capture of the video, such as a crash the user may encounter or a jump the user performs. Thus, metadata associated with captured video can be used to identify best scenes in a video recorded by a user without relying on image processing techniques or manual curating by a user.

Examples of metadata include: telemetry data (such as motion data, velocity data, and acceleration data) captured by sensors on the camera 130; location information captured by a GPS receiver of the camera 130; compass heading information; altitude information of the camera 130; biometric data such as the heart rate of the user, breathing of the user, eye movement of the user, body movement of the user, and the like; vehicle data such as the velocity or acceleration of the vehicle, the brake pressure of the vehicle, or the rotations per minute (RPM) of the vehicle engine; or environment data such as the weather information associated with the capture of the video. The video server 140 may receive metadata directly from the camera 130 (for instance, in association with receiving video from the camera), from a client device 135 (such as a mobile phone, computer, or vehicle system associated with the capture of video), or from external metadata sources 110 such as web pages, blogs, databases, social networking sites, or servers or devices storing information associated with the user (e.g., a user may use a fitness device recording fitness data).

A user can interact with interfaces provided by the video server 140 via the client device 135. The client device 135 is any computing device capable of receiving user inputs as well as transmitting and/or receiving data via the network 120. In one embodiment, the client device 135 is a conventional computer system, such as a desktop or a laptop computer. Alternatively, the client device 135 may be a device having computer functionality, such as a personal digital assistant (PDA), a mobile telephone, a smartphone or another suitable device. The user can use the client device to view and interact with or edit videos stored on the video server 140. For example, the user can view web pages including video summaries for a set of videos captured by the camera 130 via a web browser on the client device 135.

One or more input devices associated with the client device 135 receive input from the user. For example, the client device 135 can include a touch-sensitive display, a keyboard, a trackpad, a mouse, a voice recognition system, and the like. In some embodiments, the client device 135 can access video data and/or metadata from the camera 130 or one or more metadata sources 110, and can transfer the accessed metadata to the video server 140. For example, the client device may retrieve videos and metadata associated with the videos from the camera via a universal serial bus (USB) cable coupling the camera 130 and the client device 135. The client device 135 can then upload the retrieved videos and metadata to the video server 140.

In one embodiment, the client device 135 executes an application allowing a user of the client device 135 to interact with the video server 140. For example, a user can identify metadata properties using an application executing on the client device 135, and the application can communicate the identified metadata properties selected by a user to the video server 140 to generate and/or customize a video summary. As another example, the client device 135 can execute a web browser configured to allow a user to select video summary properties, which in turn can communicate the selected video summary properties to the video server 140 for use in generating a video summary. In one embodiment, the client device 135 interacts with the video server 140 through an application programming interface (API) running on a native operating system of the client device 135, such as IOS® or ANDROID™. While FIG. 1 shows a single client device 135, in various embodiments, any number of client devices 135 may communicate with the video server 140.

The video server 140 communicates with the client device 135, the metadata sources 110, and the camera 130 via the network 120, which may include any combination of local area and/or wide area networks, using both wired and/or wireless communication systems. In one embodiment, the network 120 uses standard communications technologies and/or protocols. In some embodiments, all or some of the communication links of the network 120 may be encrypted using any suitable technique or techniques. It should be noted that in some embodiments, the video server 140 is located within the camera 130 itself.

### Example Camera Configuration

FIG. 2 is a block diagram illustrating a camera system, according to one embodiment. The camera 130 includes one or more microcontrollers 202 (such as microprocessors) that control the operation and functionality of the camera 130. A lens and focus controller 206 is configured to control the operation and configuration of the camera lens. A system memory 204 is configured to store executable computer instructions that, when executed by the microcontroller 202, perform the camera functionalities described herein. A synchronization interface 208 is configured to synchronize the camera 130 with other cameras or with other external devices, such as a remote control, a second camera 130, a smartphone, a client device 135, or a video server 140.

A controller hub 230 transmits and receives information from various I/O components. In one embodiment, the controller hub 230 interfaces with LED lights 236, a display 232, buttons 234, microphones such as microphones 222, speakers, and the like.

A sensor controller 220 receives image or video input from an image sensor 212. The sensor controller 220 receives audio inputs from one or more microphones, such as microphone 212a and microphone 212b. Metadata sensors 224, such as an accelerometer, a gyroscope, a magnetometer, a global positioning system (GPS) sensor, or an altimeter may be coupled to the sensor controller 220. The metadata sensors 224 each collect data measuring the environment and aspect in which the video is captured. For example, the accelerometer 220 collects motion data, comprising velocity and/or acceleration vectors representative of motion of the camera 130, the gyroscope provides orientation data describing the orientation of the camera 130, the GPS sensor provides GPS coordinates identifying the location of the camera 130, and the altimeter measures the altitude of the camera 130. The metadata sensors 224 are rigidly coupled to the camera 130 such that any motion, orientation or change in location experienced by the camera 130 is also experienced by the metadata sensors 224. The sensor controller 220 synchronizes the various types of data received from the various sensors connected to the sensor controller 220. For example, the sensor controller 220 associates a time stamp representing when the data was captured by each sensor. Thus, using the time stamp, the measurements received from the metadata sensors 224 are correlated with the corresponding video frames captured by the image sensor 212. In one embodiment, the sensor controller begins collecting metadata from the metadata sources when the camera 130 begins recording a video. In one embodiment, the sensor controller 220 or the microcontroller 202 performs operations on the received metadata to generate additional metadata information. For example, the microcontroller may integrate the received acceleration data to determine the velocity profile of the camera 130 during the recording of a video.

Additional components connected to the microcontroller 202 include an I/O port interface 238 and an expansion pack interface 240. The I/O port interface 238 may facilitate the receiving or transmitting video or audio information through an I/O port. Examples of I/O ports or interfaces include USB ports, HDMI ports, Ethernet ports, audioports, and the like. Furthermore, embodiments of the I/O port interface 238 may include wireless ports that can accommodate wireless connections. Examples of wireless ports include Bluetooth, Wireless USB, Near Field Communication (NFC), and the like. The expansion pack interface 240 is configured to interface with camera add-ons and removable expansion packs, such as a display module, an extra battery module, a wireless module, and the like.

### Example Video Server Architecture

FIG. 3 is a block diagram of an architecture of the video server. The video server 140 in the embodiment of FIG. 3 includes a user storage module 305 (“user store” hereinafter), a video storage module 310 (“video store” hereinafter), a template storage module 315 (“template store” hereinafter), a video editing module 320, a metadata storage module 325 (“metadata store” hereinafter), a web server 330, an activity identifier 335, and an activity storage module 340 (“activity store” hereinafter). In other embodiments, the video server 140 may include additional, fewer, or different components for performing the functionalities described herein. Conventional components such as network interfaces, security functions, load balancers, failover servers, management and network operations consoles, and the like are not shown so as to not obscure the details of the system architecture.

Each user of the video server 140 creates a user account, and user account information is stored in the user store 305. A user account includes information provided by the user (such as biographic information, geographic information, and the like) and may also include additional information inferred by the video server 140 (such as information associated with a user's previous use of a camera). Examples of user information include a username, a first and last name, contact information, a user's hometown or geographic region, other location information associated with the user, and the like. The user store 305 may include data describing interactions between a user and videos captured by the user. For example, a user account can include a unique identifier associating videos uploaded by the user with the user's user account.

The video store 310 stores videos captured and uploaded by users of the video server 140. The video server 140 may access videos captured using the camera 130 and store the videos in the video store 310. In one example, the video server 140 may provide the user with an interface executing on the client device 135 that the user may use to upload videos to the video store 315. In one embodiment, the video server 140 indexes videos retrieved from the camera 130 or the client device 135, and stores information associated with the indexed videos in the video store. For example, the video server 140 provides the user with an interface to select one or more index filters used to index videos. Examples of index filters include but are not limited to: the type of equipment used by the user (e.g., ski equipment, mountain bike equipment, etc.), the type of activity being performed by the user while the video was captured (e.g., snowboarding, mountain biking, etc.), the time and data at which the video was captured, or the type of camera 130 used by the user.

In some embodiments, the video server 140 generates a unique identifier for each video stored in the video store 310. In some embodiments, the generated identifier for a particular video is unique to a particular user. For example, each user can be associated with a first unique identifier (such as a 10-digit alphanumeric string), and each video captured by a user is associated with a second unique identifier made up of the first unique identifier associated with the user concatenated with a video identifier (such as an 8-digit alphanumeric string unique to the user). Thus, each video identifier is unique among all videos stored at the video store 310, and can be used to identify the user that captured the video.

The metadata store 325 stores metadata associated with videos stored by the video store 310. For instance, the video server 140 can retrieve metadata from the camera 130, the client device 135, or one or more metadata sources 110, can associate the metadata with the corresponding video (for instance by associating the metadata with the unique video identifier), and can store the metadata in the metadata store 325. The metadata store 325 can store any type of metadata, including but not limited to the types of metadata described herein. It should be noted that in some embodiments, metadata corresponding to a video is stored within a video file itself, and not in a separate storage module.

The web server 330 provides a communicative interface between the video server 140 and other entities of the environment of FIG. 1. For example, the web server 330 can access videos and associated metadata from the camera 130 or the client device 135 to store in the video store 310 and the metadata store 325, respectively. The web server 330 can also receive user input provided to the client device 135, can request video summary templates or other information from a client device 135 for use in generating a video summary, and can provide a generated video summary to the client device or another external entity.

### Event of Interest/Activity Identification

The video editing module 320 analyzes metadata associated with a video to identify best scenes of the video based on identified events of interest or activities, and generates a video summary including one or more of the identified best scenes of the video. The video editing module 320 first accesses one or more videos from the video store 310, and accesses metadata associated with the accessed videos from the metadata store 325. The video editing module 320 then analyzes the metadata to identify events of interest in the metadata. Examples of events of interest can include abrupt changes or anomalies in the metadata, such as a peak or valley in metadata maximum or minimum values within the metadata, metadata exceeding or falling below particular thresholds, metadata within a threshold of predetermine values (for instance, within 20 meters of a particular location or within), and the like. The video editing module 320 can identify events of interest in videos based on any other type of metadata, such as a heart rate of a user, orientation information, and the like.

For example, the video editing module 320 can identify any of the following as an event of interest within the metadata: a greater than threshold change in acceleration or velocity within a pre-determined period of time, a maximum or above-threshold velocity or acceleration, a maximum or local maximum altitude, a maximum or above-threshold heart rate or breathing rate of a user, a maximum or above-threshold audio magnitude, a user location within a pre-determined threshold distance from a pre-determined location, a threshold change in or pre-determined orientation of the camera or user, a proximity to another user or location, a time within a threshold of a pre-determined time, a pre-determined environmental condition (such as a particular weather event, a particular temperature, a sporting event, a human gathering, or any other suitable event), or any other event associated with particular metadata.

In some embodiments, a user can manually indicate an event of interest during capture of the video. For example, a user can press a button on the camera or a camera remote or otherwise interact with the camera during the capture of video to tag the video as including an event of interest. The manually tagged event of interest can be indicated within metadata associated with the captured video. For example, if a user is capturing video while snowboarding and presses a camera button associated with manually tagging an event of interest, the camera creates metadata associated with the captured video indicating that the video includes an event of interest, and indicating a time or portion within the captured video at which the tagged event of interest occurs. In some embodiments, the manual tagging of an event of interest by a user while capturing video is stored as a flag within a resulting video file. The location of the flag within the video file corresponds to a time within the video at which the user manually tags the event of interest.

As noted above, the video editing module 320 can identify events of interest based on activities performed by users when the videos are captured. For example, a jump while snowboarding or a crash while skateboarding can be identified as events of interest. Activities can be identified by the activity identifier module 335 based on metadata associated with the video captured while performing the activities. Continuing with the previous example, metadata associated with a particular altitude and a parabolic upward and then downward velocity can be identified as a “snowboarding jump”, and a sudden slowdown in velocity and accompanying negative acceleration can be identified as a “skateboarding crash”.

The activity identifier module 335 can receive a manual identification of an activity within videos from one or more users. In some embodiments, activities can be tagged during the capture of video. For instance, if a user is about to capture video while performing a snowboarding jump, the user can manually tag the video being captured or about to be captured as “snowboarding jump”. In some embodiments, activities can be tagged after the video is captured, for instance during playback of the video. For instance, a user can tag an activity in a video as a skateboarding crash upon playback of the video.

Activity tags in videos can be stored within metadata associated with the videos. For videos stored in the video store 310, the metadata including activity tags associated with the videos is stored in the metadata store 325. In some embodiments, the activity identifier module 335 identifies metadata patterns associated with particular activities and/or activity tags. For instance, metadata associated with several videos tagged with the activity “skydiving” can be analyzed to identify similarities within the metadata, such as a steep increase in acceleration at a high altitude followed by a high velocity at decreasing altitudes. Metadata patterns associated with particular activities are stored in the activity store 340.

Once metadata patterns associated with particular activities are identified, the activity identifier module 335 can identify metadata patterns in metadata associated with other videos, and can tag or associate other videos associated with metadata including the identified metadata patterns with the activities associated with the identified metadata patterns. The activity identifier module 335 can identify and store a plurality of metadata patterns associated with a plurality of activities within the activity store 340. Metadata patterns stored in the activity store 340 can be identified within videos captured by one user, and can be used by the activity identifier module 335 to identify activities within videos captured by the user. Alternatively, metadata patterns can be identified within videos captured by a first plurality of users, and can be used by the activity identifier module 335 to identify activities within videos captured by a second plurality of users including at least one user not in the first plurality of users. In some embodiments, the activity identifier module 335 aggregates metadata for a plurality of videos associated with an activity and identifies metadata patterns based on the aggregated metadata. As used herein, “tagging” a video with an activity refers to the association of the video with the activity. Activities tagged in videos can be used as a basis to identify best scenes in videos (as described above), and to select video clips for inclusion in video summary templates (as described below).

Videos tagged with activities can be automatically uploaded to or shared with an external system. For instance, if a user captures video, the activity identifier module 335 can identify a metadata pattern associated with an activity in metadata of the captured video, in real-time (as the video is being captured), or after the video is captured (for instance, after the video is uploaded to the video server 140). The video editing module 320 can select a portion of the captured video based on the identified activity, for instance a threshold amount of time or frames around a video clip or frame associated with the identified activity. The selected video portion can be uploaded or shared to an external system, for instance via the web server 330. The uploading or sharing of video portions can be based on one or more user settings and/or the activity identified. For instance, a user can select one or more activities in advance of capturing video, and captured video portions identified as including the selected activities can be uploaded automatically to an external system, and can be automatically shared via one or more social media outlets.

### Best Scene Identification and Video Summary Generation

The video editing module 320 identifies best scenes associated with the identified events of interest for inclusion in a video summary. Each best scene is a video clip, portion, or scene (“video clips” hereinafter), and can be an entire video or a portion of a video. For instance, the video editing module 320 can identify video clips occurring within a threshold amount of time of an identified event of interest (such as 3 seconds before and after the event of interest), within a threshold number of frames of an identified event of interest (such as 24 frames before and after the event of interest), and the like. The amount of length of a best scene can be pre-determined, and/or can be selected by a user.

The amount or length of video clip making up a best scene can vary based on an activity associated with captured video, based on a type or value of metadata associated with captured video, based on characteristics of the captured video, based on a camera mode used to capture the video, or any other suitable characteristic. For example, if an identified event of interest is associated with an above-threshold velocity, the video editing module 320 can identify all or part of the video corresponding to above-threshold velocity metadata as the best scene. In another example, the length of a video clip identified as a best scene can be greater for events of interest associated with maximum altitude values than for events of interest associated with proximity to a pre-determined location.

For events of interest manually tagged by a user, the length of a video clip identified as a best scene can be pre-defined by the user, can be manually selected by the user upon tagging the event of interest, can be longer than automatically-identified events of interest, can be based on a user-selected tagging or video capture mode, and the like. The amount or length of video clips making up best scenes can vary based on the underlying activity represented in captured video. For instance, best scenes associated with events of interest in videos captured while boating can be longer than best scenes associated with events of interest in videos captured while skydiving.

The identified video portions make up the best scenes as described herein. The video editing module 320 generates a video summary by combining or concatenating some or all of the identified best scenes into a single video. The video summary thus includes video portions of events of interest, beneficially resulting in a playable video including scenes likely to be of greatest interest to a user. The video editing module 320 can receive one or more video summary configuration selections from a user, each specifying one or more properties of the video summary (such as a length of a video summary, a number of best scenes for inclusion in the video summary, and the like), and can generate the video summary according to the one or more video summary configuration selections. In some embodiments, the video summary is a renderable or playable video file configured for playback on a viewing device (such as a monitor, a computer, a mobile device, a television, and the like). The video summary can be stored in the video store 310, or can be provided by the video server 140 to an external entity for subsequent playback. Alternatively, the video editing module 320 can serve the video summary from the video server 140 by serving each best scene directly from a corresponding best scene video file stored in the video store 310 without compiling a singular video summary file prior to serving the video summary. It should be noted that the video editing module 320 can apply one or more edits, effects, filters, and the like to one or more best scenes within the video summary, or to the entire video summary during the generation of the video summary.

In some embodiments, the video editing module 320 ranks identified best scenes. For instance, best scenes can be ranked based on activities with which they are associated, based on metadata associated with the best scenes, based on length of the best scenes, based on a user-selected preference for characteristics associated with the best scenes, or based on any other suitable criteria. For example, longer best scenes can be ranked higher than shorter best scenes. Likewise, a user can specify that best scenes associated with above-threshold velocities can be ranked higher than best scenes associated with above-threshold heart rates. In another example, best scenes associated with jumps or crashes can be ranked higher than best scenes associated with sitting down or walking Generating a video summary can include identifying and including the highest ranked best scenes in the video summary.

In one example, the video editing module 320 analyzes metadata associated with accessed videos chronologically to identify an order of events of interest presented within the video. For example, the video editing module 320 can analyze acceleration data to identify an ordered set of video clips associated with acceleration data exceeding a particular threshold. In some embodiments, the video editing module 320 can identify an ordered set of events occurring within a pre-determined period of time. Each event in the identified set of events can be associated with a best scene; if the identified set of events is chronologically ordered, the video editing module 320 can generate a video summary by a combining video clips associated with each identified event in the order of the ordered set of events.

In some embodiments, the video editing module 320 can generate a video summary for a user using only videos associated with (or captured by) the user. To identify such videos, the video editing module 320 can query the video store 310 to identify videos associated with the user. In some embodiments, each video captured by all users of the video server 140 includes a unique identifier identifying the user that captured the video and identifying the video (as described above). In such embodiments, the video editing module 320 queries the video store 310 with an identifier associated with a user to identify videos associated with the user. For example, if all videos associated with User A include a unique identifier that starts with the sequence “X1Y2Z3” (an identifier unique to User A), the video editing module 320 can query the video store 310 using the identifier “X1Y2Z3” to identify all videos associated with User A. The video editing module 320 can then identify best scenes within such videos associated with a user, and can generate a video summary including such best scenes as described herein.

### Video Summary Templates

In one embodiment, the video editing module 320 retrieves video summary templates from the template store 315 to generate a video summary. The template store 315 includes video summary templates each describing a sequence of video slots for including in a video summary. In one example, each video summary template may be associated with a type of activity performed by the user while capturing video or the equipment used by the user while capturing video. For example, a video summary template for generating video summaries of a ski tip can differ from the video summary template for generating video summaries of a mountain biking trip.

Each slot in a video summary template is a placeholder to be replaced by a video clip or scene when generating a video summary. Each slot in a video summary template can be associated with a pre-defined length, and the slots collectively can vary in length. The slots can be ordered within a template such that once the slots are replaced with video clips, playback of the video summary results in the playback of the video clips in the order of the ordered slots replaced by the video clips. For example, a video summary template may include an introductory slot, an action slot, and a low-activity slot. When generating the video summary using such a template, a video clip can be selected to replace the introductory slot, a video clip of a high-action event can replace the action slot, and a video clip of a low-action event can replace the low-activity slot. It should be noted that different video summary templates can be used to generate video summaries of different lengths or different kinds.

In some embodiments, video summary templates include a sequence of slots associated with a theme or story. For example, a video summary template for a ski trip may include a sequence of slots selected to present the ski trip narratively or thematically. In some embodiments, video summary templates include a sequence of slots selected based on an activity type. For example, a video summary template associated with surfing can include a sequence of slots selected to highlight the activity of surfing.

Each slot in a video summary template can identify characteristics of a video clip to replace the slot within the video summary template. For example, a slot can identify one or more of the following video clip characteristics: motion data associated with the video clip, altitude information associated with the video clip, location information associated with the video clip, weather information associated with the clip, or any other suitable video characteristic or metadata value or values associated with a video clip.

To generate a video summary using a video summary template, the video editing module 320 accesses a video summary template from the template store 315. The accessed video summary template can be selected by a user, can be automatically selected (for instance, based on an activity type or based on characteristics of metadata or video for use in generating the video summary), or can be selected based on any other suitable criteria. The video editing module 320 then selects a video clip for each slot in the video summary template, and inserts the selected video clips into the video summary in the order of the slots within the video summary template.

To select a video clip for each slot, the video editing module 320 can identify a set of candidate video clips for each slot, and can select from the set of candidate video clips (for instance, by selecting the determined best video from the set of candidate video clips according to the principles described above). In some embodiments, selecting a video clip for a video summary template slot identifying a set of video characteristics includes selecting a video clip from a set of candidate video clips that include the identified video characteristics. For example, if a slot identifies a video characteristic of “velocity over 15 mph”, the video editing module 320 can select a video clip associated with metadata indicating that the camera or a user of the camera was traveling at a speed of over 15 miles per hour when the video was captured, and can replace the slot within the video summary template with the selected video clip.

In some embodiments, video summary template slots are replaced by video clips identified as best scenes (as described above). For instance, if a set of candidate video clips are identified for each slot in a video summary template, if one of the candidate video slips identified for a slot is determined to be a best scene, the best scene is selected to replace the slot. In some embodiments, multiple best scenes are identified for a particular slot; in such embodiments, one of the best scenes can be selected for inclusion into the video summary based on characteristics of the best scenes, characteristics of the metadata associated with the best scenes, a ranking of the best scenes, and the like.

In some embodiments, when generating a video summary using a video summary template, the video editing module 320 can present a user with a set of candidate video clips for inclusion into one or more video summary template slots, for instance using a video summary generation interface. In such embodiments, the user can presented with a pre-determined number of candidate video clips for a particular slot, and, in response to a selection of a candidate scene by the user, the video editing module 320 can replace the slot with the selected candidate video clip. In some embodiments, the candidate video clips presented to the user for each video summary template slot are the video clips identified as best scenes (as described above). Once a user has selected a video clip for each slot in a video summary template, the video editing module 320 generates a video summary using the user-selected video clips based on the order of slots within the video summary template.

In one embodiment, the video editing module 320 generates video summary templates automatically, and stores the video summary templates in the template store 315. The video summary templates can be generated manually by experts in the field of video creation and video editing. The video editing module 320 may provide a user with a user interface allowing the user to generate video summary templates. Video summary templates can be received from an external source, such as an external template store. Video summary templates can be generated based on video summaries manually created by users, or based on an analysis of popular videos or movies (for instance by including a slot for each scene in a video).

### System Operation

FIG. 4 is a flowchart illustrating a method for selecting video portions to include in a video summary, according to one embodiment. A request to generate a video summary is received 410. The request can identify one or more videos for which a video summary is to be generated. In some embodiments, the request can be received from a user (for instance, via a video summary generation interface on a computing device), or can be received from a non-user entity (such as the video server 140 of FIG. 1). In response to the request, video and associated metadata is accessed 420. The metadata includes data describing characteristics of the video, the context or environment in which the video was captured, characteristics of the user or camera that captured the video, or any other information associated with the capture of the video. As described above, examples of such metadata include telemetry data describing the acceleration or velocity of the camera during the capture of the video, location or altitude data describing the location of the camera, environment data at the time of video capture, biometric data of a user at the time of video capture, and the like.

Events of interest within the accessed video are identified 430 based on the accessed metadata associated with the video. Events of interest can be identified based on changes in telemetry or location data within the metadata (such as changes in acceleration or velocity data), based on above-threshold values within the metadata (such as a velocity threshold or altitude threshold), based on local maximum or minimum values within the data (such as a maximum heart rate of a user), based on the proximity between metadata values and other values, or based on any other suitable criteria. Best scenes are identified 440 based on the identified events of interest. For instance, for each event of interest identified within a video, a portion of the video corresponding to the event of interest (such as a threshold amount of time or a threshold number of frames before and after the time in the video associated with the event of interest) is identified as a best scene. A video summary is then generated 450 based on the identified best scenes, for instance by concatenating some or all of the best scenes into a single video.

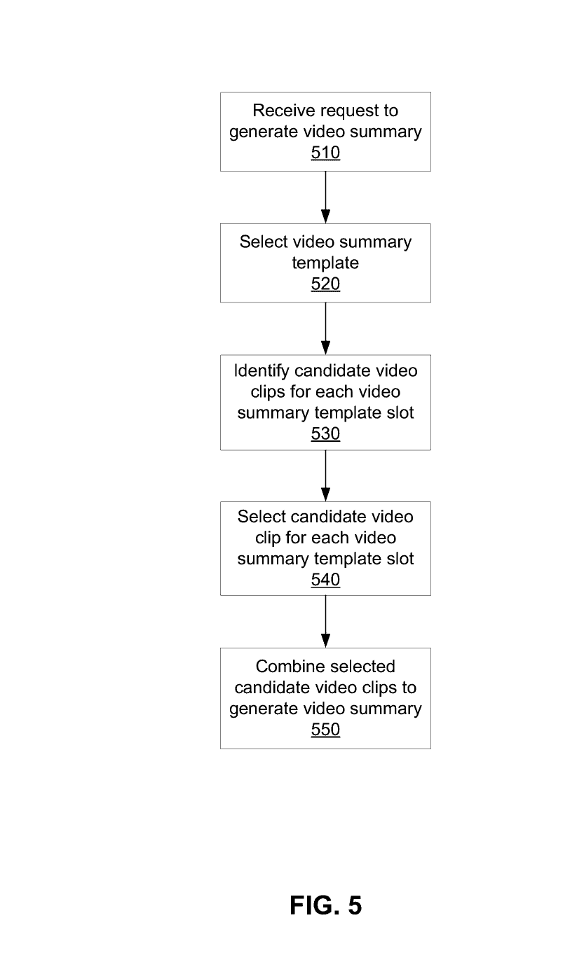

FIG. 5 is a flowchart illustrating a method for generating video summaries using video templates, according to one embodiment. A request to generate a video summary is received 510. A video summary template is selected 520 in response to receiving the request. The selected video summary template can be a default template, can be selected by a user, can be selected based on an activity type associated with captured video, and the like. The selected video summary template includes a plurality of slots, each associated with a portion of the video summary. The video slots can specify video or associated metadata criteria (for instance, a slot can specify a high-acceleration video clip).

A set of candidate video clips is identified 530 for each slot, for instance based on the criteria specified by each slot, based on video clips identified as “best scenes” as described above, or based on any other suitable criteria. For each slot, a candidate video clip is selected 540 from among the set of candidate video clips identified for the slot. In some embodiments, the candidate video clips in each set of candidate video clips are ranked, and the most highly ranked candidate video clip is selected. The selected candidate video clips are combined 550 to generate a video summary. For instance, the selected candidate video clips can be concatenated in the order of the slots of the video summary template with which the selected candidate video clips correspond.

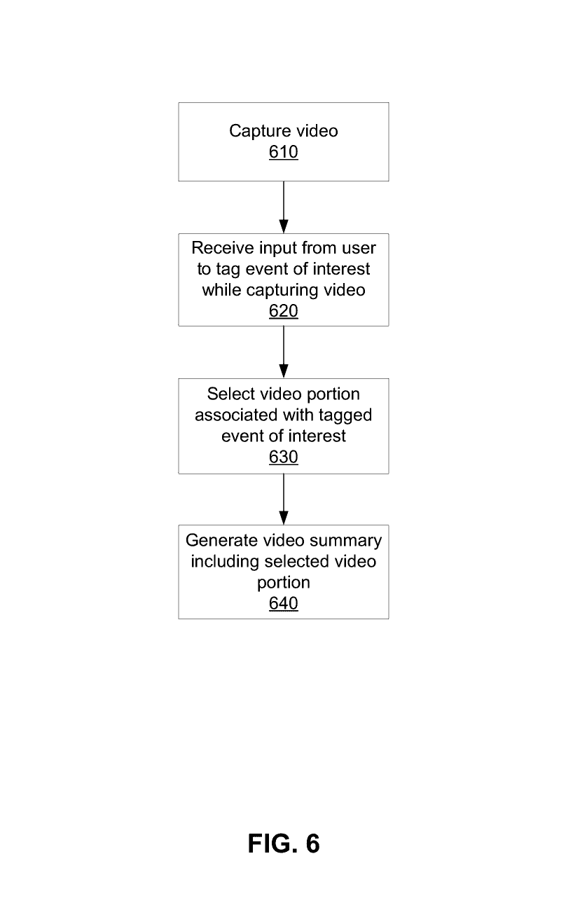

FIG. 6 is a flowchart illustrating a method for generating video summaries of videos associated with user-tagged events, according to one embodiment. Video is captured 610 by a user of a camera. During video capture, an input is received 620 from the user indicating an event of interest within the captured video. The input can be received, for instance, through the selection of a camera button, a camera interface, or the like. An indication of the user-tagged event of interest is stored in metadata associated with the captured video. A video portion associated with the tagged event of interest is selected 630, and a video summary including the selected video portion is generated 640. For instance, the selected video portion can be a threshold number of video frames before and after a frame associated with the user-tagged event, and the selected video portion can be included in the generated video summary with one or more other video portions.

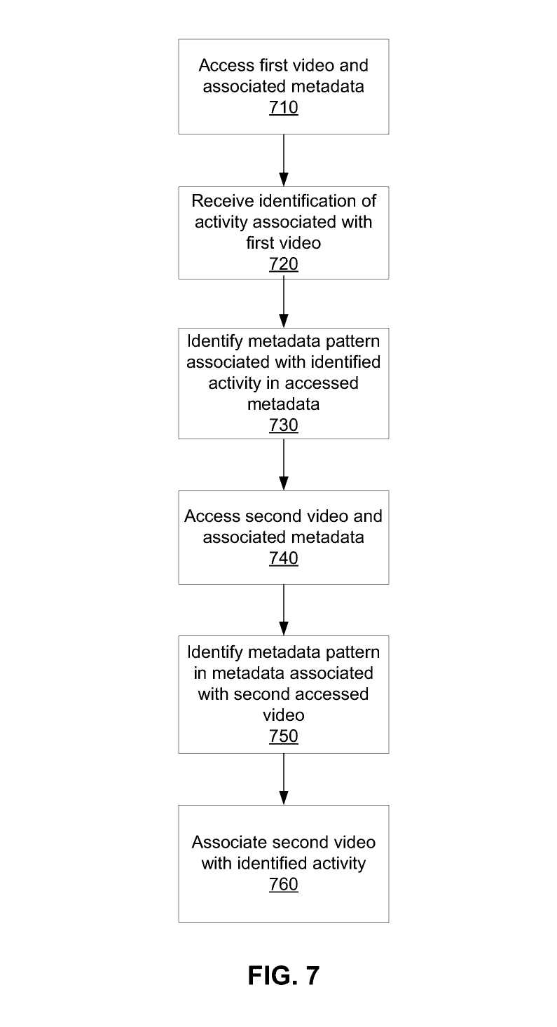

FIG. 7 is a flowchart illustrating a method 700 of identifying an activity associated with a video, according to one embodiment. A first video and associated metadata is accessed 710. An identification of an activity associated with the first video is received 720. For instance, a user can identify an activity in the first video during post-processing of the first video, or during the capture of the first video. A metadata pattern associated with the identified activity is identified 730 within the accessed metadata. The metadata pattern can include, for example, a defined change in acceleration metadata and altitude metadata.

A second video and associated metadata is accessed 740. The metadata pattern is identified 750 within the metadata associated with the second video. Continuing with the previous example, the metadata associated with the second video is analyzed and the defined change in acceleration metadata and altitude metadata is identified within the examined metadata. In response to identifying the metadata pattern within the metadata associated with the second video, the second video is associated 750 with the identified activity.

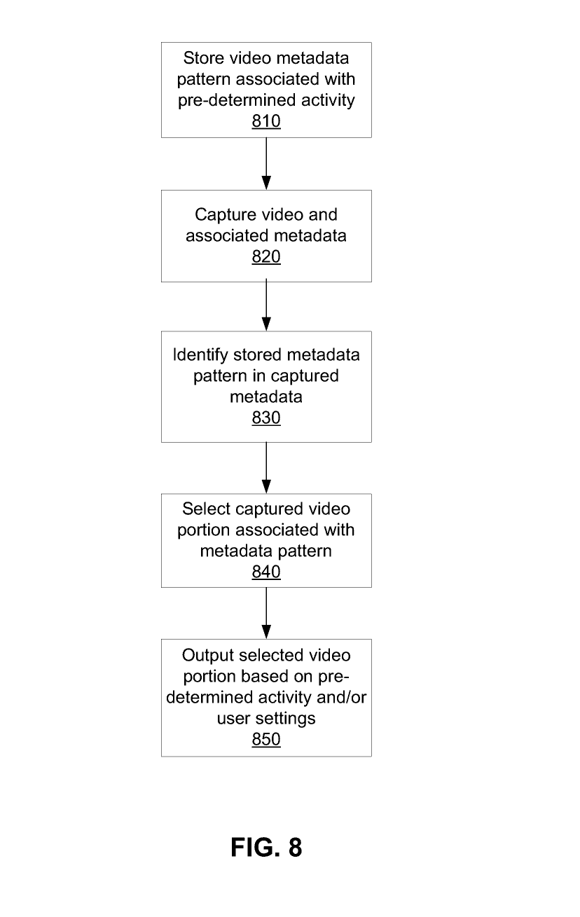

FIG. 8 is a flowchart illustrating a method 800 of sharing a video based on an identified activity within the video, according to one embodiment. Metadata patterns associated with one or more pre-determined activities are stored 810. Video and associated metadata are subsequently captured 820, and a stored metadata pattern associated with an activity is identified 830 within the captured metadata. A portion of the captured video associated with the metadata pattern is selected 840, and is outputted 850 based on the activity associated with the identified metadata pattern and/or one or more user settings. For instance, a user can select “snowboarding jump” and “3 seconds before and after” as an activity and video portion length, respectively. In such an example, when a user captures video, a metadata pattern associated with a snowboarding jump can be identified, and a video portion consisting of 3 seconds before and 3 seconds after the video associated with the snowboarding jump can automatically be uploaded to a social media outlet.

### Camera Docking and Video Uploading

In some embodiments, a camera (such as the camera 130 of FIG. 1) can be configured to communicatively couple to a camera dock (not illustrated in the embodiment of FIG. 1). The camera dock can include a power bus configured to provide power to the camera, a communication bus configured to receive video data from the camera, a memory component configured to store received video data, a network component configured to upload received or stored video to an external computing system (such as a cloud server), as well as one or more processing devices configured to perform the functionalities described herein.

A camera dock can be configured for placement on or attachment to a surface or object with a security viewpoint. For instance, the camera dock can be placed on a top surface of a bookshelf with a viewpoint of a room, or can be attached to a windowsill with a viewpoint of a doorway. In other words, the camera dock can include one or more attachment or securing mechanism that allow for the camera dock to be placed in a stationary location such that, when the camera is communicatively coupled to the dock, the camera is substantially stationary relative to the local environment of the camera. A stationary dock can allow a coupled camera to function as a security camera, by enabling the capture of video from a substantially fixed perspective, and by enabling the streaming of captured video via the camera dock to an external computing device.

The bit-rate of video captured by the camera can be dependent based upon the docking status of the camera. For instance, if the camera is docked, the video captured by the camera can be captured at a lower bit-rate than if the camera was undocked. As video captured by a docked camera is likely to be relatively stable from frame to frame (since the video is captured from a substantially fixed perspective), the magnitude of compression can be selected or adjusted to account for the low inter-frame motion. As video captured by an undocked camera (and thus a camera potentially in motion) is likely to include inter-frame motion, the magnitude of compression can be selected or adjusted to account for the inter-frame motion and to reduce inter-frame blur in the captured video.

A camera can be configured to capture video at two different qualities simultaneously. For instance, a camera can capture video at a first resolution and a second resolution higher than the first resolution. The camera can also be configured to capture video at a first frame rate and a second frame rate higher than the first frame rate. In some embodiments, the camera can upload the lower-quality video to an external computing device, for instance via the camera dock or communicative capabilities of the camera. In some embodiments, the lower-quality captured video is uploaded or stream automatically, for instance to a cloud server or to a computer for viewing by a user or owner of the camera. In embodiments where the camera does not have communicative capabilities and is not communicatively coupled to a camera dock, the camera can store the lower-quality version of the captured video, for instance within a local storage or memory component. The camera can be configured to store the higher-quality version of the captured video to a local or external storage component, such as a camera memory or a camera dock memory. As the higher-quality version of the captured video requires additional storage space, the camera or camera dock can be configured to store the higher-quality version of the captured video in a loop, replacing the oldest portion of the stored higher-quality version of the captured video with newly captured higher-quality video. In some embodiments, the camera captures video at two different qualities simultaneously using wavelet compression, wherein the higher-quality video stream is the captured video itself, and wherein the lower-quality video stream is a lower-resolution wavelet component of the captured video.

An event of interest can be identified by the camera within the captured video, for instance as described herein. In some embodiments, the event of interest is identified by the camera automatically, based on metadata associated with the captured video. In other embodiments, the event of interest is manually identified, for instance, by a user viewing a stream of the lower-quality version of the video streamed from a camera as the video is captured to a computer or mobile device display associated with the user. In such embodiments, the user can identify an event of interest within the video stream displayed on the user's device, and the user's device can provide an indication of the identified event of interest to the camera.

Upon identifying an event of interest within the captured video, the camera can be configured to select a video clip associated with the identified event of interest. As noted above, selecting a video clip can include identifying a threshold portion of video before and after the identified event of interest, for instance based on a camera or user-selected configuration. The camera can flag or save a portion of the higher-quality version of the captured video corresponding to the selected video clip. For instance, the camera can store the portion of the higher-quality version of the captured video to a memory separate from a captured video loop or can provide the portion of higher-quality video to the camera dock for storage. As the higher-quality video portion takes longer to upload to an external computer device (such as a cloud server) than a lower-quality video portion, the camera or camera dock can upload the higher-quality video portion over a longer time interval, at a slower rate, when bandwidth is available, or based on any other suitable factor.

In some embodiments, the camera can stream or upload a lower-quality video stream to an external computing system, such as a cloud server, in real-time (or after a threshold delay). In some embodiments, the bit-rate or the compression magnitude of the lower-quality video stream is selected such that the lower-quality video can be streamed or uploaded to the external computing system given any bandwidth constraints associated with the external computing system. The lower-quality video stream can be stored by the external computing system, and can be subsequently accessed, retrieved, or displayed by a user. The camera can subsequently stream higher-quality video portions associated with selected video clips corresponding to the identified events of interest to the external computing device. Upon receiving the higher-quality video portions, the external computing device can replace lower-quality video portions corresponding to the received higher-quality video portions with the higher-quality video portions. Such embodiments allow for users to retrieve and playback video stored at the external computing device in higher resolution or quality during video corresponding to events of interest, and in lower resolution or quality during the remaining video. Such embodiments save bandwidth and power by limiting the quantity of higher-quality video uploaded to an external computing device to important portions of video (corresponding to events of interest), while still uploading the remainder of the video, albeit at a lower quality.

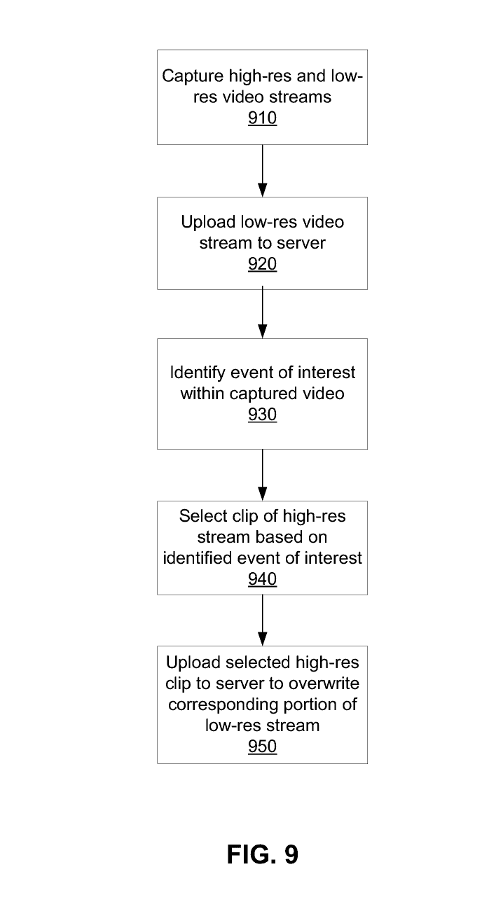

FIG. 9 is a flowchart illustrating a method of uploading captured video to a server, according to one embodiment. A high resolution video stream and a low resolution video stream are captured 910 simultaneously. The low resolution video stream is a lower resolution version of the high resolution video stream, and can be, for example, a low resolution wavelet component of a wavelet-encoded high resolution video stream. The low resolution video stream is uploaded 920 to a server (such as a cloud server). An event of interest is identified 930 within the captured video. A video clip of the high resolution video stream is selected 940 based on the identified event of interest. The selected high resolution video clip is uploaded 950 to the server, the server configured to overwrite a corresponding portion of the low resolution video stream with the uploaded high resolution video clip.

### Camera-to-Camera Control

In some embodiments, a camera (such as the camera 130 of FIG. 1) can be configured to communicatively couple to and control other cameras (not illustrated in the embodiment of FIG. 1). A camera configured to control other cameras is referred to herein as a “master camera”, and the cameras controlled by the master camera are referred to herein as “slave cameras”. The master camera can control one or more camera parameters for the slave cameras, such as resolution, frame rate, capture mode, video parameters associated with capturing video, and/or can provide control instructions to the slave cameras to control slave camera selection, video capture timing (one or more times to start and/or stop capturing video), and the like. The master camera can also control the capture of video by one or more slave cameras based on events of interest detected within video captured by the master camera and/or one or more slave cameras, based on properties of video captured by the master camera and/or one or more slave cameras, based on pre-determined sequences of video capture (for instance, defining start and stop times for video capture for each of one or more cameras), based on motion detected by one or more cameras, based on user-selected control settings, and the like.

In some embodiments, the master camera can select one or more cameras in a set of slave cameras from which to capture video. The slave cameras can be selected based on a known location of the slave cameras (for instance, relative to the master camera or relative to a location associated with an identified event of interest), based on a field of view of the slave cameras, based on capabilities of the slave cameras (for instance, resolution and/or frame rate capabilities, processing capabilities, storage capabilities, and camera mode capabilities), based on user-selected settings, based on a pre-determined camera protocol (for instance, identifying one or more slave cameras from which to capture video, and one or more time periods during which video is to be captured by each slave camera), or based on any other suitable criteria.

Within a set of cameras, a master camera can be identified, the master camera can select one or more slave cameras from the remaining cameras within the set of cameras, and the master camera can communicate and synchronize (for instance, time synchronization based on a time tracked or maintained by the master camera) with the slave cameras. In some embodiments, the master camera and the slave cameras begin capturing video according to pre-determined camera and/or video capture parameters. The master camera can provide an updated set of camera parameters or control instructions (such as those described above) to each slave camera, and the slave cameras can begin capturing video based on the provided camera parameters or control instructions.

Video data from each camera can be uploaded to a centralized computing device or storage location (such as a computer, handheld device, cloud server, video editing service, or the like) for storage, editing, and display. The video data the cameras can be combined based on synchronized time data associated with the video data (for instance, each camera, during video capture, can embed a timestamp into the captured video data on a frame by frame or other basis, and the video data can be combined such that all frames associated with the same or a similar timestamp can be associated). In some embodiments, the video data can be edited based on camera or video capture parameters associated with the cameras that captured the video data. For instance, if a master camera provided a camera capture sequence defining ordered video capture time intervals for each of one or more slave cameras, the video data can be edited, organized, or combined such that the video data captured during each video capture time intervals is ordered according to the order of video capture time intervals.

In some embodiments, a master camera identifies an event of interest within video captured by the master camera, and provides an indication of the event of interest to one or more slave cameras. In response, the slave cameras tag or flag video captured during a time interval of interest associated with the event of interest (for instance, a pre-determine time interval, or a time interval provided by the master camera) as associated with an event of interest. Alternatively, a slave camera can identify an event of interest within video captured by the slave camera, can provide an indication of the event of interest to the master camera, and the master camera can 1) tag or flag video captured by the master camera during an associated time interval of interest as associated with the event of interest, and 2) provide an indication of the event of interest to one or more additional slave cameras, which in turn can tag or flag video captured by the one or more additional slave cameras during an associated time interval of interest as associated with the event of interest. During editing, video data captured by a plurality of cameras associated with an event of interest can be combined or associated (for instance, if four cameras each captured video associated with the same event of interest, the video data from each camera can be combined into a 2×2 display of the video data, or can be associated as associated with the same event of interest)

### Event of Interest Identification Based on User Sensor Information

In some embodiments, a user's location can be monitored and/or recorded using a beacon, sensor, tag, or other tracking device (“beacon” hereinafter). Examples include a dedicated GPS receiver, a smart phone or device with GPS or other location-detection capability, an RFID tag, an infrared transmitter, and the like. The beacon enables location information describing a user's location to be determined and stored for subsequent access. This location information, received from the beacon, includes sensor metadata that is collected in real-time as a user moves within a given area, and is stored in association with timestamps each indicating a time at which such location information is captured. The location information can be used to identify events of interest and associated video scenes, for instance by a video server, as described herein, particularly when used in combination with a set of cameras each associated with a set of boundaries defining the camera's field of view.

In another possible embodiment, the beacon can also act as an audio capture device, whereby a user's audio track is recorded and either stored or transmitted for later use. This audio information can subsequently be overlaid onto captured video information by the video server.

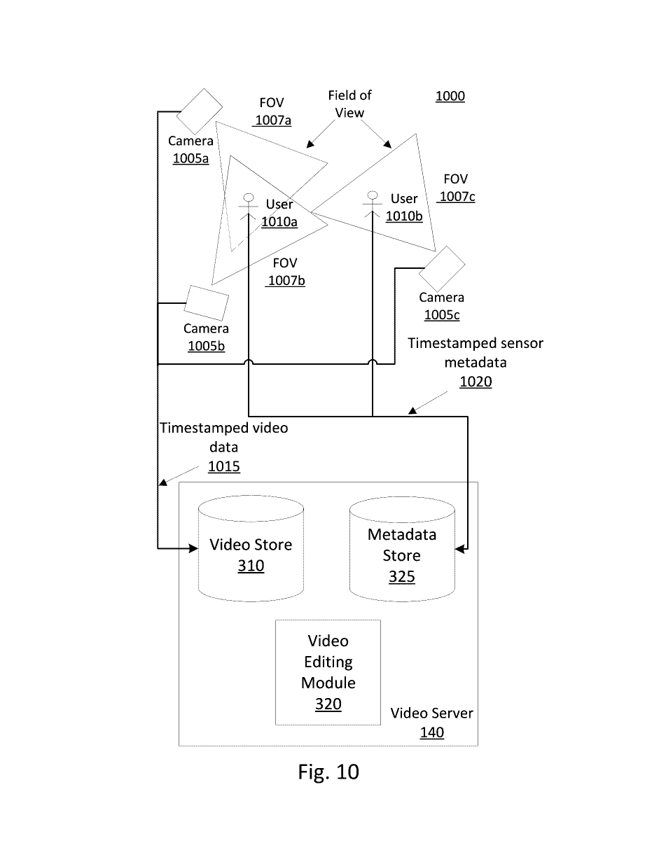

FIG. 10 is a block diagram illustrating a video capture environment, according to one embodiment. The environment 1000 of FIG. 10 includes a plurality of cameras (1005a, 1005b, and 1005c), each associated with a corresponding field of view (“FOV”) (1007a, 1007b, 1007c). Each FOV 1007 corresponds to a FOV boundary describing a set of geographic boundaries such that objects and people within the set of geographic boundaries will be visible within the FOV boundary of the corresponding camera (and thus, will be visible within video captured by the camera during times when the objects and people are within the FOV boundary). The environment 1000 also includes two users, user 1010a (located within FOVs 1007a and 1007b) and user 1010b (located within FOV 1007c).

In the embodiment of FIG. 10, each user 1010a and 1010b is associated with a beacon (for instance, either carried by or attached to a user or equipment of the user) that stores timestamped sensor metadata 1020. In some embodiments, the timestamped sensor metadata is geographic coordinates or other location information describing a location of a user at each time point within a time interval. The cameras 1005 capture, timestamp, and store video data 1015. It should be noted that the cameras 1005 can be stationary, can be moved, and can be associated with either a pre-defined stationary FOV or a moving FOV. The cameras 1005 can be located, for instance, at pre-identified locations within a sporting event location (such as a ski run or basketball court), at a public event (such as a parade or concert), at a private event (such as a house party), or at any other suitable location. In some embodiments, the FOVs of one or more cameras can overlap, while in other embodiments, the FOVs may have no overlap.

The environment 1000 also includes a video server 140 (for instance, the video server 140 of FIG. 3), which includes a video store 310, a metadata store 325, and a video editing module 320. In some embodiments, the video server 140 is located geographically proximate to the cameras 1005, while in other embodiments, the video server is located remotely from the cameras (for instance, the video server may be a cloud server or home computer). The video server 140 receives the timestamped video data 1015 and stores the timestamped video data in the video store 310. The video server 140 also receives the timestamped sensor metadata 1020 and stores the timestamped sensor metadata 1020 in the metadata store 325. In some embodiments, the timestamped video data 1015 is provided by the cameras 1005 immediately upon capture (or shortly thereafter), for instance when the cameras are configured in a livestreaming configuration. In other embodiments, the timestamped video data 1015 is stored by the cameras 1005 and is subsequently provided to the video server 140 (for instance, in response to a request or input from a user, after the passage of a period of time, periodically, or the like). Similarly, in certain embodiments the timestamped sensor metadata 1020 may be provided in substantially real-time to the video server 140, while in other embodiments, the timestamped sensor metadata is subsequently provided to the video server 140 (for instance, in response to a user input to upload the metadata, in response to the docking of the beacon that captured the metadata, and the like).

The video server 140, and particularly the video editing module 320, can identify the presence of a user within a FOV of one or more cameras in the network as an event of interest (EOI). Referring again to FIG. 10, user 1010a is located within the FOV 1007a and the FOV 1007b, indicating that the user 1010a is visible in footage captured by both cameras 1005a and 1005b. Similarly, user 1010b is located within the FOV 1007c, and thus user 1010b is visible in footage captured by camera 1005c. The video editing module 320 can identify the presence of a user within a FOV of a camera (and thus, can identify an event of interest) by determining if, at a particular time, the timestamped sensor metadata 1020 associated with a user identifies a location within a FOV boundary of one or more cameras. In some embodiments, the FOV boundaries of each camera 1005 are known to the video editing module 320 (for instance, the FOV module can store a lookup table identifying the FOV boundaries of each camera 1005), while in other embodiments, the video editing module 320 can request and receive the FOV boundaries from an external entity (such as another server, or the cameras 1005 themselves).

For a particular time, the video editing module 320 can identify metadata 1020 with a corresponding timestamp, and can determine if the location identified within the identified metadata is located within one or more FOV boundaries of the cameras 1005. In response to determining that the identified location is located within one or more FOV boundaries, the video editing module 320 can identify an event of interest within the video data 1015 associated with the cameras associated with the one or more FOV boundaries in which the identified location is located at, for each of the associated cameras, the timestamp included within the video data 1015 corresponding to the particular time. The video editing module can identify a video clip associated with each identified event of interest (for instance, corresponding video data within a threshold amount of time before and after the identified event of interest), as described in greater detail above. In other words, the events of interest identified within the environment 1000 and the corresponding identified video clips include the presence of a user 1010 within the FOV of one or more cameras during video capture, and the corresponding presence of the user 1010 within the captured video data. In some embodiments, the video server 140 can identify events of interest corresponding to a single user's presence within one or more FOVs of the cameras 1005, while in other embodiments, the video server can identify events of interest for each of a plurality of users, for each of one or more camera FOVs.

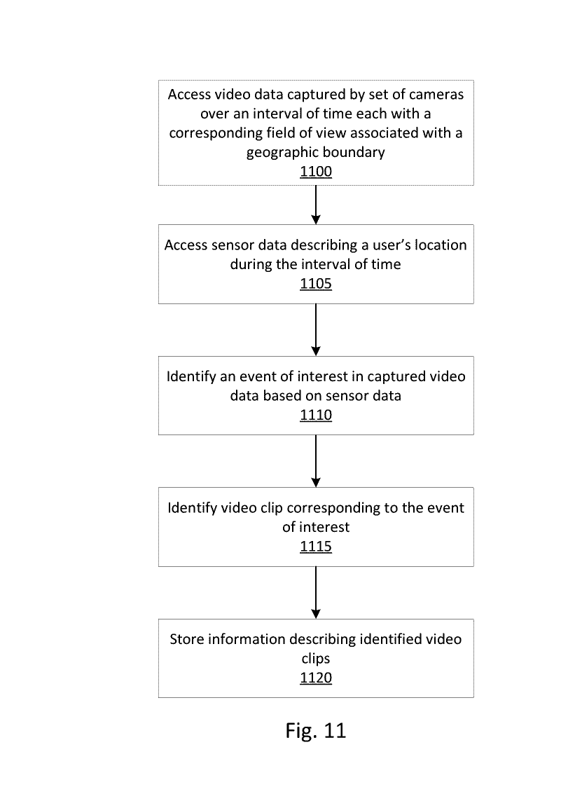

FIG. 11 is a flowchart illustrating a method for identifying events of interest within video data, according to one embodiment. A video server (or other computing device) accesses 1100 timestamped video data captured by a set of one or more cameras over an interval of time, each corresponding to a FOV associated with a geographic boundary. The video server then accesses 1105 sensor data describing a user's location during the interval of time. In some embodiments, the data describing a user's location is captured by a beacon with location-detection functionality (such as a GPS receiver).

The video server identifies 1110 an event of interest in the accessed video data. The video server can identify an event of interest by comparing the accessed sensor data associated with a particular timestamp to the geographic boundaries associated with the FOV of each camera in the set cameras. As described above, the sensor data may include audio data captured by a beacon, which is also analyzed to identify an event of interest. If the accessed sensor data includes a location within one or more FOVs, the video server identifies an event of interest within the video data captured by a camera associated with one of the one or more FOVs at the particular timestamp (or a timestamp within a threshold amount of time from the particular timestamp). The video server identifies 1115 a video clip corresponding to the event of interest, for instance a threshold amount of video data captured by the camera before and after the identified event of interest. The server stores 1120 the identified video clip (or information describing the identified video clip) for subsequent use in generating a video summary, for subsequent access by an external entity, for subsequent display, or the like.

In some embodiments, one or more of the cameras 1005 can determine when a user carrying or associated with a beacon is located within the FOV of the cameras. For instance, the beacon can be a transmitter (such as an infrared transmitter) that emits signals visible to the cameras 1005. In such embodiments, upon capturing video, a camera 1005 can store a flag within metadata corresponding to the captured video data indicating the presence of a user within the FOV of the camera when the camera detects the presence of the beacon (and thus, the user) within the FOV of the camera. For example, a camera 1005 located at a particular location on ski run can continuously capture video over an interval of time. Prior to detecting a beacon carried by a user within the FOV of the camera 1005, the camera will not include a flag within the captured video data indicating the presence of the user within the FOV. When the user skis into and across the FOV of the camera 1005, the camera can detect the beacon carried by the user, and can include a flag within the captured video data indicating the presence of the user within the FOV. When the user subsequently skis out of the FOV of the camera 1005, the camera will subsequently not include the flag within the captured video data. In other words, only the portion of the video captured during the interval of time corresponding to the time when the user skis into and across the FOV of the camera 1005 will include a flag indicating the presence of the user within the FOV. Such flags indicate events of interest within video data, namely the presence of a user within captured video data.

In some embodiments, the beacon can emit a signal identifying the user associated with the beacon. For instance, if the beacon is an infrared transmitter, the beacon can identify a unique pattern corresponding to and identifying the user associated with the beacon, and a camera 1005 capturing video data when the user is within the FOV of the camera can include the identity of the user within the flag corresponding to the video data. In some embodiments, the camera 1005 stores the identifying signal or pattern emitted by the beacon in the flag corresponding to the video data, and the video server 140 subsequently identifies the user based on the stored identifying signal or pattern. In some embodiments, each of a plurality of users is associated with a different beacon, each emitting a unique identifying signal. In such embodiments, each of one or more cameras 1005 can store overlapping flags corresponding to captured video data associated with each different user based on time interval during which the beacon associated with each user is detected.

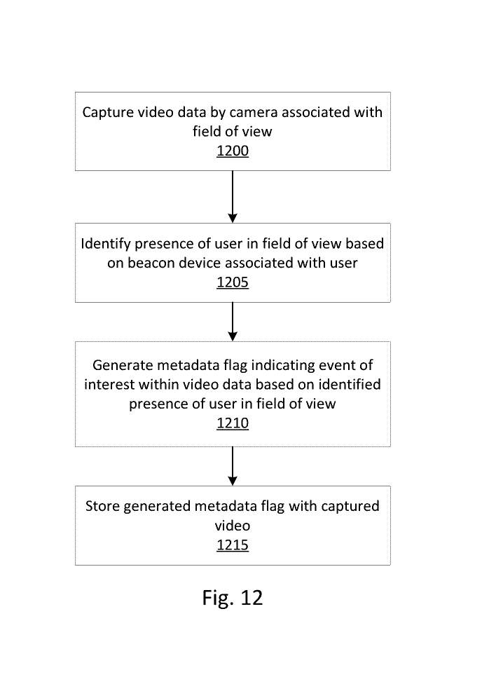

FIG. 12 is a flowchart illustrating a method for identifying events of interest within video data, according to one embodiment. Video is captured 1200 by a camera associated with a FOV. The presence of a user within the FOV is identified based on beacon associated with user. In some embodiments, the beacon emits a signal that the camera can detect, such as an infrared signal. A metadata flag is generated 1210 indicating an event of interest within the video data based on the identified presence of the user within the FOV. In events where the beacon emits a signal identifying the user, the metadata flag can identify the user or can include the signal identifying the user. The metadata flag is stored 1215 in conjunction with the captured video for subsequent access, for instance by a video server as described above.

### Additional Configuration Considerations

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for a camera expansion module as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for capturing video comprising;
accessing, by a video server from a video store, video captured by each of a plurality of cameras over an interval of time, each camera associated with a corresponding field of view;
accessing, by the video server from a data store, data captured by sensor devices each associated with a corresponding user, the data captured by a sensor device describing a location of the corresponding user over the interval of time;
identifying, by the video server, events of interest within the captured video, each event of interest corresponding to a time within the interval of time during which data captured by a sensor device associated with a first user describes a location of the first user within a field of view corresponding to at least one of the plurality of cameras;
identifying, by the video server, a video clip corresponding to each event of interest, each identified video clip comprising a portion of video captured within a capture interval starting before and ending after the time corresponding to the event of interest, the portion of captured video captured by the camera with a field of view in which the first user is located at the time corresponding to the event of interest; and
storing information describing the identified video clips.

2. The method of claim 1, wherein the accessed video comprises one of: video data transmitted from one or more of the plurality of cameras in real-time to the video server, and video data stored by one or more of the plurality of cameras and subsequently provided to the video server.

3. The method of claim 1, wherein the accessed data captured by the sensor devices comprises one of: timestamped sensor metadata transmitted from one or more of the sensor devices in real-time to the video server, and timestamped sensor metadata stored by one or more of the sensor devices and subsequently provided to the video server.

4. The method of claim 1, wherein identifying events of interest within the captured video comprises querying a lookup table mapping field of view information to an identity of each camera.

5. The method of claim 1, wherein identifying events of interest within the captured video comprises one of: identifying a user's presence within one or more fields of view of one or more cameras, and identifying multiple users' presence within one or more fields of view of one or more cameras.

6. A system for capturing video, comprising:
a video server comprising a processor and a non-transitory computer-readable storage medium storing computer instructions for execution by the processor, the instructions when executed causing a processor to:
access, from a video store, video captured from each of a plurality of cameras over an interval of time, each camera associated with a corresponding field of view;
access, from a data store, data captured by sensor devices each associated with a corresponding user, the data captured by a sensor device describing a location of the corresponding user over the interval of time;
identify events of interest within the captured video, each event of interest corresponding to a time within the interval of time during which data captured by a sensor device associated with a first user describes a location of the first user within a field of view corresponding to at least one of the plurality of cameras;
identify a video clip corresponding to each event of interest, each identified video clip comprising a portion of video captured within a capture interval starting before and ending after the time corresponding to the event of interest, the portion of captured video captured by the camera with a field of view in which the first user is located at the time corresponding to the event of interest; and
store information describing the identified video clips.

7. The system of claim 6, wherein the accessed video comprises one of: video data transmitted from one or more of the plurality of cameras in-real time to the video server, and video data stored by one or more of the plurality of cameras and subsequently provided to the video server.

8. The system of claim 6, wherein the accessed data captured by the sensor devices comprises one of: timestamped sensor metadata transmitted from one or more of the sensor devices in real-time to the video server, and timestamped sensor metadata stored by one or more of the sensor devices and subsequently provided to the video server.

9. The system of claim 6, wherein the instructions that cause the processor to identify events of interest within the captured video further comprise instructions that cause the processor to query a lookup table mapping field of view information to an identity of each camera.

10. The system of claim 6, wherein the instructions that cause the processor to identify events of interest within the captured video comprise instructions that cause the processor to one of: identify a user's presence within one or more fields of view of one or more cameras, and identify multiple users' presence within one or more fields of view of one or more cameras.

11. A method for capturing video comprising;
capturing, by a camera corresponding to a field of view, video data over a capture interval of time;
identifying, for each of one or more users, times within the capture interval of time at which the user is located within the field of view based on a beacon device associated with the user, the beacon device identifying the user;
generating metadata in conjunction with the captured video, the metadata identifying, for each identified time, an event of interest identifying a user and indicating the presence of the user within the video portion at the identified time; and
storing the generated metadata in conjunction with the captured video.

12. The method of claim 11, wherein each beacon is configured to emit a unique signal corresponding to and identifying the user associated with the beacon, wherein identifying times within the capture interval of time comprises identifying a user based on the emitted unique signal, and wherein the generated metadata includes a flag for each identified time identifying that the user is within a field of view.

13. The method of claim 12, wherein the generated metadata includes the flag for the sub-interval of time within the capture interval of time during which the user is within the field of view.

14. The method of claim 11, wherein the camera is configured to store overlapping flags corresponding to the concurrent presence of multiple users in the field of view corresponding to the camera.

15. The method of claim 11, wherein a video server receives beacon signals captured by each of a plurality of cameras including the camera, and wherein the video server is configured to identify the presence of users within captured video received from the plurality of cameras.

16. A system for capturing video comprising:
a camera comprising a processor and a non-transitory computer-readable storage medium storing computer instructions for execution by the processor, the instructions when executed causing a processor to:
capture video data over a capture interval of time;
identify, for each of one or more users, times within the capture interval of time at which the user is located within the field of view based on a beacon device associated with the user, the beacon device identifying the user;
generate metadata in conjunction with the captured video, the metadata identifying, for each identified time, an event of interest identifying a user and indicating the presence of the user within the video portion at the identified time; and
store the generated metadata in conjunction with the captured video.

17. The system of claim 16, wherein each beacon is configured to emit a unique signal corresponding to and identifying the user associated with the beacon, wherein identifying times within the capture interval of time comprises identifying a user based on the emitted unique signal, and wherein the generated metadata includes a flag for each identified time identifying that the user is within a field of view.

18. The system of claim 17, wherein the generated metadata includes the flag for the sub-interval of time within the capture interval of time during which the user is within the field of view.

19. The system of claim 16, wherein the camera is configured to store overlapping flags corresponding to the concurrent presence of multiple users in the field of view corresponding to the camera.

20. The system of claim 16, wherein a video server receives beacon signals captured by each of a plurality of cameras including the camera, and wherein the video server is configured to identify the presence of users within captured video received from the plurality of cameras.
